(19) United States
(12) Patent Application Publication
(10) Pub. No.: US 2004/0011210 A1
(43) Pub. Date: Jan. 22, 2004

(54) Bread maker and method of controlling the same

(75) Inventors: Jang-woo Lee, Suwon city (KR); Yong-hyun Kwon, Suwon city (KR); Dong-bin Lim, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon city (KR)

(21) Appl. No.: 10/345,257

(22) Filed: Jan. 16, 2003

(30) Foreign Application Priority Data
Jul. 19, 2002 (KR) 2002-42593

(51) Int. Cl. A23L 1/00

(52) U.S. Cl. 99/348

(57) ABSTRACT

A bread maker including a main body forming an oven compartment; a pair of kneading drums spaced apart from each other inside the oven compartment, each kneading drum having a holding part holding opposite ends of a mixing bag containing ingredients for bread; a bar code reader reading a bar code printed on, or applied to, the mixing bag to obtain bar code information; a timer recording a present time; and a controller determining whether the mixing bag has expired by comparing an expiration date of the mixing bag obtained from the bar code information with the present time transmitted from the timer, and warning a user when the mixing bag expires.

### CROSS-REFERENCE TO RELATED APPLICATIONS

This application claims the benefit of Korean Application No. 2002-42593, filed Jul. 19, 2002, in the Korean Intellectual Property Office, the disclosure of which is incorporated herein by reference.

### BACKGROUND OF THE INVENTION

1. Field of the Invention

The present invention relates to a bread maker and a method of controlling the same, and, more particularly, to a bread maker and a method of controlling the same, in which an expiration date of a mixing bag is automatically checked to warn a user of the expiration of the contents of the mixing bag.

2. Description of the Related Art

Generally, a bread maker automatically performs kneading, leavening, and baking of bread dough, and provides fresh bread to a user, so that a user only needs to put ingredients in the bread maker. Some bread makers use a mixing bag to make the bread. The mixing bag is made of a flexible material, and contains mixed ingredients such as flour, sugar, etc., for the bread. On the surface of the mixing bag is printed or applied a bar code that includes baking information on kneading time, leavening time and temperature, baking time and temperature, moisture, etc., and product information about the ingredients, such as an expiration date, etc.

The conventional bread maker that uses a mixing bag includes a pair of kneading drums that each has a holding part to hold the mixing bag, and a bar code reader behind one of the kneading drums to read the bar code. Opposite ends of the mixing bag are held by the holding parts of the kneading drums, and the mixing bag is wound on the kneading drums as the kneading drums are rotated. At this time, the bar code reader reads the bar code printed on, or applied to, the mixing bag, so that the baking information of the bar code is transmitted to the bread maker. Then, the bread maker automatically performs kneading, leavening, and baking of the dough, etc., according to the transmitted baking information. Thus, because it is easy and safe to use the bread maker and the mixing bag, a user, including children and older persons, can easily control the bread maker and safely make the bread.

However, the ingredients, such as flour contained in the mixing bag, may go bad if not used within a certain amount of time. Therefore, the expiration date of the mixing bag is specified, and a user must check the expiration date of the mixing bag before making the bread.

However, a user is likely to carelessly forget to check the expiration date of the mixing bag. Further, if a user does not have the ability to read the expiration date of the mixing bag, such as illiterate children or older persons having poor eyesight, it is difficult to check the expiration date of the mixing bag.

### SUMMARY OF THE INVENTION

It is an aspect of the present invention to provide a bread maker and a method of controlling the same, in which an expiration date of a mixing bag is automatically checked to warn a user of the expiration of the mixing bag.

It is another aspect of the present invention is to provide a bread maker and a method of controlling the same, in which an expired mixing bag is prevented from being used in making bread.

Additional aspects and advantages of the invention will be set forth in part in the description that follows, and, in part, will be obvious from the description, or may be learned by practice of the invention.

To achieve the above and/or other aspects according to the present invention, there is provided a bread maker including a main body forming an oven compartment; a pair of kneading drums spaced apart from each other inside the oven compartment, each kneading drum having a holding part holding opposite ends of a mixing bag containing ingredients for bread; a bar code reader reading a bar code printed on, or applied to, the mixing bag to obtain bar code information; a timer recording a present time; and a controller determining whether the mixing bag has expired by comparing an expiration date of the mixing bag obtained from the bar code information with the present time transmitted from the timer, and warning a user when the mixing bag is determined to be expired.

The bread maker further includes a display part on the main body, wherein the controller controls the display part to display the expiration of the mixing bag when the mixing bag is determined to be expired.

The bread maker further includes a drum driving part rotating the kneading drums, wherein the controller controls the drum driving part to rotate the kneading drums in a direction that unwinds the mixing bag from the kneading drums when the mixing bag is determined to be expired.

The bread maker further includes a drum driving part rotating the kneading drums, wherein the controller controls the drum driving part to stop the kneading drums from rotating when the mixing bag is determined to be expired.

To achieve the above and/or other aspects according to the present invention, there is provided a method of controlling a bread maker having a main body forming an oven compartment, and a pair of kneading drums spaced apart from each other inside the oven compartment, each kneading drum having a holding part holding opposite ends of a mixing bag containing ingredients for bread, the method comprising reading an expiration date in a bar code printed on, or applied to, the mixing bag; determining whether the mixing bag has expired according to the read expiration date; and warning a user of expiration of the mixing bag when the mixing bag is determined to be expired.

The method further includes rotating the kneading drums in a direction that unwinds the mixing bag from the kneading drums when the mixing bag is determined to be expired.

The method further includes stopping the kneading drums from rotating when the mixing bag is determined to be expired.

To achieve the above and/or other aspects according to the present invention, there is provided a method of controlling a bread maker having a main body forming an oven compartment, and a pair of kneading drums spaced apart from each other inside the oven compartment, each kneading drum having a holding part holding opposite ends of a mixing bag containing ingredients for bread, the method including attaching the mixing bag to the kneading drums positioned at an initial position, and rotating the kneading drums to wind the mixing bag on the kneading drums; sensing rotation of the kneading drums; reading a bar code on the mixing bag to obtain bar code information, and determining an expiration date of the mixing bag from the bar code information; determining a current date, and comparing the expiration date with the current date to determine whether the mixing bag has expired; displaying a warning message, when the mixing bag is determined to be expired, to warn a user of the expiration of the mixing bag, and rotating the kneading drums to unwind the mixing bag therefrom and return the kneading drums to the initial position based upon the sensed rotation, and preventing further rotation of the kneading drums; and controlling the kneading drums, when the mixing bag is determined not to be expired, to knead the dough according to the bar code information.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and aspects and advantages of the present invention will become apparent and more readily appreciated from the following description of the embodiments, taken in conjunction with the accompanying drawings, of which:

FIG. 1 is a perspective view of a mixing bag and a bread maker according to an embodiment of the present invention;

FIG. 2 is a sectional view of a part of the bread maker, taken along line I-I in FIG. 1, which reads a bar code;

FIG. 3 is a control block diagram of the bread maker according to the embodiment of the present invention;

FIG. 4 is a control flowchart of the bread maker according to the embodiment of the present invention, in which the bar code is automatically read;

FIG. 5 is a perspective view of a mixing bag and a bread maker according to another embodiment of the present invention; and

FIG. 6 is a control flowchart of the bread maker according to the embodiment of the present invention shown in FIG. 5.

### DETAILED DESCRIPTION OF THE PREFERRED EMBODIMENT

Hereinafter, embodiments of the present invention will be described in detail with reference to the attached drawings, wherein the like reference numerals refer to the like elements throughout. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

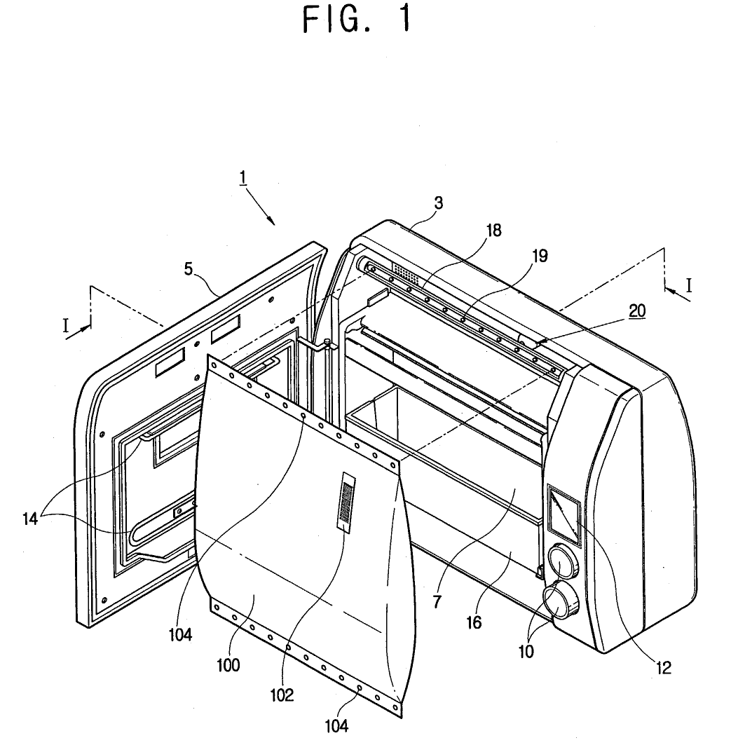

FIG. 1 is a perspective view of a mixing bag and a bread maker according to an embodiment of the present invention. As shown therein, the bread maker 1 includes a main body 3 forming an oven compartment 7, and a door 5 opening and closing the front opening of the oven compartment 7. On the right front of the main body 3 are an operation selecting part 10 allowing a user to select an operation of the bread maker 1, and a display part 12 displaying an operating state of the bread maker 1. In the right rear of the main body 3 is a component compartment (not shown) accommodating a plurality of components for operating the bread maker 1. In the oven compartment 7 and the door 5 are a plurality of heaters 14 for heating the inside of the oven compartment 7 (the heaters 14 inside the oven compartment 7 are not shown). Inside the oven compartment 7 is a baking tray 16 to contain the dough.

At inner upper and lower parts of the oven compartment 7 are parallel kneading drums 18 (the lower kneading drum 18 is not shown). Each kneading drum 18 has a plurality of holding projections 19 protruding lengthwise therefrom and holding opposite ends of a mixing bag 100, so that the mixing bag 100 can be attached to the kneading drums 18. One of the kneading drums 18, particularly, the kneading drum 18 placed at the inner upper part of the oven compartment 7, is close to a bar code reader 20 that reads a bar code 102 printed on, or applied to, the mixing bag 100, which is held by the holding projections 19 of the kneading drums 18 and wound on the kneading drums 18.

The mixing bag 100 is held by the holding projections 19 of the kneading drums 18. The mixing bag 100 is made of a flexible material, and contains mixed ingredients such as flour, sugar, etc., for the bread. On the surface of the mixing bag 100 is printed or applied the bar code 102, which includes baking information on kneading time, leavening time and temperature, baking time and temperature, moisture, etc., and product information about the ingredients, such as an expiration date, etc. The opposite ends of the mixing bag 100 have a plurality of holding holes 104 that are placed on the holding projections 19 of the kneading drums 18, thereby attaching the mixing bag 100 to the kneading drums 18.

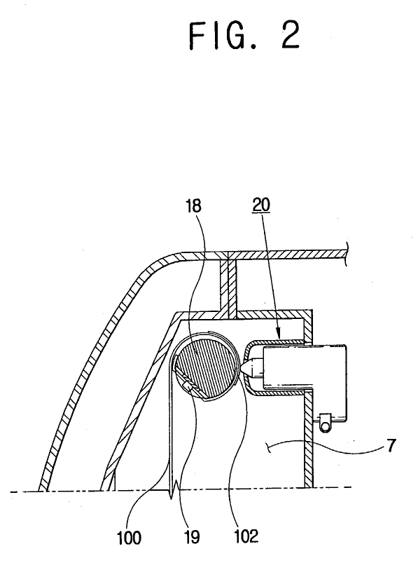

FIG. 2 is a sectional view of a part of the bread maker that reads the bar code 102, taken along line I-I in FIG. 1. As shown therein, to make the bread maker 1 read the bar code information, the mixing bag 100 is first attached to the kneading drums 18, and the kneading drums 18 are rotated in response to a user selection of the operation selecting part 10. As the kneading drums 18 are rotated, the mixing bag 100 is partially wound on the kneading drums 18, with the bar code 102 being in contact with an optical sensor (not shown) of the bar code reader 20, which is behind the upper kneading drum 18. Thus, the bar code reader 20 reads the bar code 102 printed on, or applied to, the mixing bag 100.

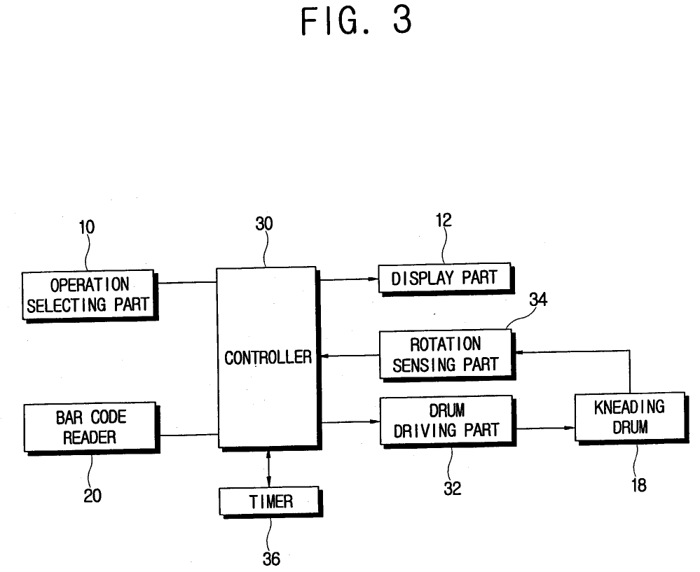

FIG. 3 is a control block diagram of the bread maker 1. As shown therein, the operation selecting part 10 allows a user to select an operation of the bread maker 1. The display part 12 displays an operating state of the bread maker 1. The bar code reader 20 reads the bar code 102 on the mixing bag 100. A drum driving part 32 rotates the kneading drums 18. A rotation sensing part 34 senses rotation of the kneading drums 18. A timer 36 records the present time. A controller 30 controls the above components.

To read the bar code information, a user first selects an operation through the operation selecting part 10. The controller 30 controls the drum driving part 32 to rotate the kneading drums 18 by supplying electric power to a motor (not shown), thereby winding the mixing bag 100 on the kneading drums 18. As the mixing bag 100 is wound on the kneading drums 18, the bar code reader 20 reads the bar code 102 on the mixing bag 100. According to the baking information read by the bar code reader 20, the controller 30 controls the drum driving part 32 to drive the kneading drums 18 to knead the dough, and controls a heater driving part (not shown) to drive the heaters 14 to leaven and bake the dough.

The timer 36 records the present time, and transmits the time to the controller 30. An auxiliary power supply (not shown) such as a battery, etc., supplies electric power to the timer 36 to operate the timer 36 continuously, even when the bread maker 1 is turned off.

The controller 30 compares the expiration date of the mixing bag 100 read by the bar code reader 20 with the present time transmitted from the timer 36, thereby determining whether the mixing bag 100 has expired.

If the mixing bag 100 has expired, the controller 30 controls the display part 12 to display a warning message to warn the user of the expiration of the mixing bag 100. The warning of the expiration may be aurally achieved by a buzzer, etc. In this case, the bread maker 1 includes a sound circuit (not shown) and a speaker (not shown), and the controller 30 controls the sound circuit to make a buzzing sound through the speaker.

When the mixing bag 100 has expired, the controller 30 controls the drum driving part 32 to rotate the kneading drums 18 to unwind the mixing bag 100 from the kneading drums 18 and return the kneading drums 18 to an initial position, which is the position at which the mixing bag 100 is attached to the kneading drums 18. The kneading drums 18 are returned to the initial position based upon a rotated position of the kneading drums 18 sensed by the rotation sensing part 34. Hence, the expired mixing bag 100 is easily removed from the kneading drums 18.

After the kneading drums 18 have been returned to the initial position, the controller 30 cuts off the electric power supplied to the drum driving part 32, thereby preventing the drum driving part 32 from rotating the kneading drums 18. Hence, the kneading drums 18 stop kneading the dough contained in the expired mixing bag 100. Thus, the bread maker 1 discontinues the bread making process, thereby preventing spoiled ingredients from being made into the bread.

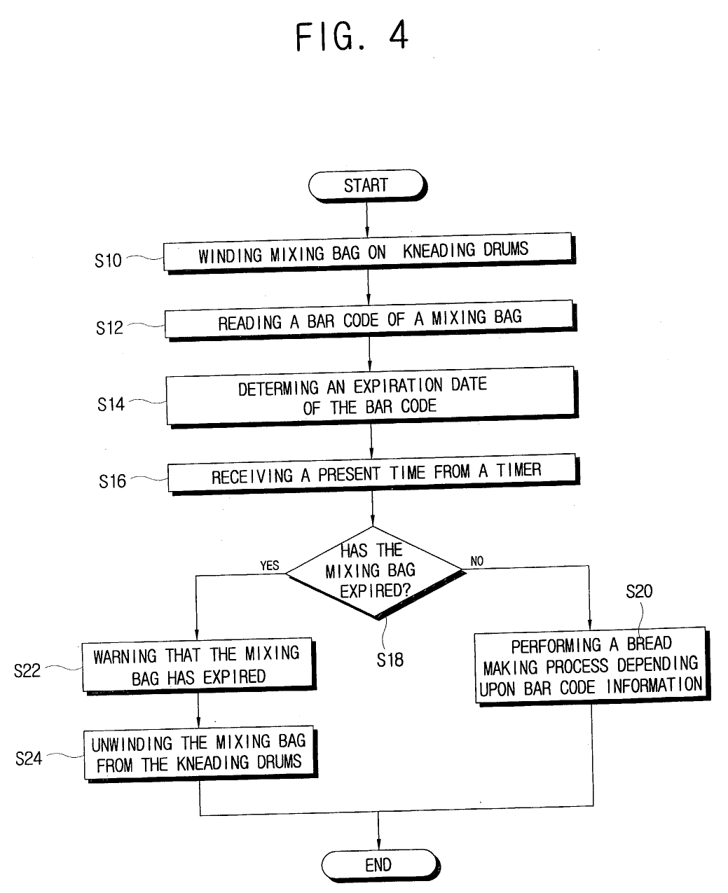

The bread maker 1 is controlled as follows. Referring to FIG. 4, first, the mixing bag 100 is attached to and wound on the kneading drums 18 (S10). Then, the bar code reader 20 reads the bar code 102 on the mixing bag 100, and transmits the bar code information to the controller 30 (S12). The controller 30 determines the expiration date of the mixing bag 100 from the bar code information (S14). The controller 30 receives the present time from the timer 36 (S16). Thereafter, the controller 30 compares the expiration date of the mixing bag 100 with the present time transmitted from the timer 36, thereby determining whether the mixing bag 100 has expired (S18).

When it is determined that the mixing bag 100 has not expired, the controller 30 controls the kneading drums 18 and the heaters 14 to perform the bread making process according to the baking information (S20).

However, when it is determined that the mixing bag 100 has expired, the controller 30 controls the display part 12 to display a warning message to warn the user of the expiration of the mixing bag 100 (S22). Simultaneously, the controller 30 controls the drum driving part 32 to rotate the kneading drums 18 in a direction that unwinds the mixing bag 100 from the kneading drums 18, thereby allowing the mixing bag 100 to be easily removed from the kneading drums 18 (S24). Thus, the bread maker 1 stops the expired mixing bag 100 from being kneaded, so that the bread making process is discontinued.

When it is determined that the mixing bag 100 has expired, the mixing bag 100 is unwound from the kneading drums 18. Also, the controller 30 cuts off the electric power supplied to the drum driving part 32, thereby preventing the drum driving part 32 from further rotating the kneading drums 18.

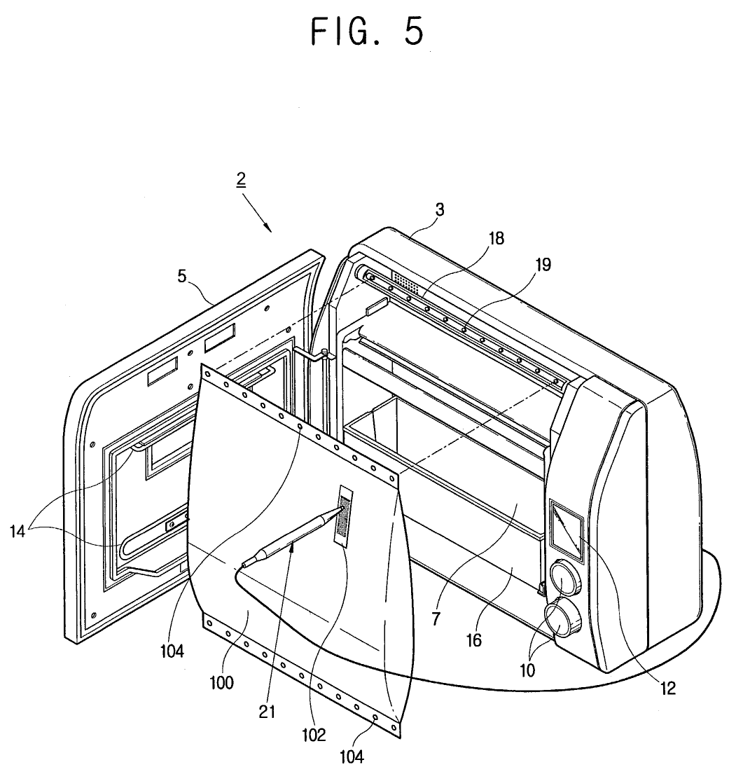

In the embodiment described above, the bar code reader 20 is placed near the upper kneading drum 18, and automatically reads the bar code 102 on the mixing bag 100. However, in another embodiment of the present invention, a handheld bar code reader 21 may be used to manually read the bar code 102, as shown in FIG. 5.

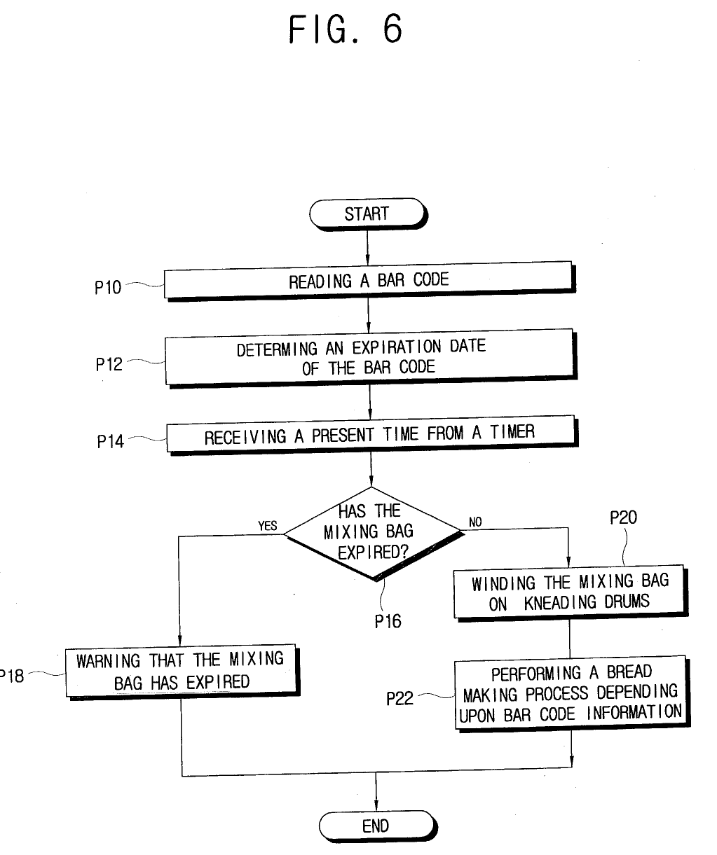

FIG. 6 is a control flowchart of a bread maker according to the embodiment of the present invention in which the bar code 102 is manually read. As shown therein, first, a user inputs the bar code information to the controller 30 using a handheld bar code reader 21 that is electrically connected to the bread maker 2 (P10). Then, the controller 30 determines the expiration date of the mixing bag 100 from the bar code information (P12). The controller 30 receives the present time from the timer 36 (P14). Thereafter, the controller 30 compares the expiration date of the mixing bag 100 with the present time transmitted from the timer 36, thereby determining whether the mixing bag 100 has expired (P16).

When it is determined that the mixing bag 100 has not expired, the controller 30 controls the kneading drums 18 to wind the mixing bag 100 thereon to knead the dough (P20), and controls the kneading drums 18 and the heaters 14 to perform the bread making process on the basis of the baking information (P22).

Oppositely, when it is determined that the mixing bag 100 has expired, the controller 30 controls the display part 12 to display a warning message to warn a user of the expiration of the mixing bag 100 (P18) and discontinues the bread making process. That is, even though the user selects the operation selection part 10 to rotate the kneading drums 18, the controller 30 prevents the kneading drums 18 from rotating, so that the mixing bag 100 cannot be wound on the kneading drums 18. Hence, it is impossible to perform the bread making process. The controller 30 discontinues the bread making process until new bar code information on a new mixing bag 100 indicates the new mixing bag 100 has not expired, so that the expired mixing bag 100 is prevented from being used in making bread.

In the embodiments of the present invention described above, the display part 12 displays the warning message to warn the user of the expiration of the mixing bag 100. However, the warning of the expiration may be aurally achieved by using a buzzer, etc.

As described above, according to the embodiments of the present invention, the bread maker 1, 2 determines whether the mixing bag 100 has expired on the basis of the expiration date provided on the bar code 102 on the mixing bag 100. When the mixing bag 100 has expired, the bread maker 1, 2 prevents the bread making process from being performed and automatically returns the kneading drums 18 to the initial position by rotating the kneading drums 18 in a direction that unwinds the mixing bag 100 from the kneading drums 18, allowing the user to easily remove the expired mixing bag 100 from the kneading drums 18 so that the expired mixing bag 100 is prevented from being used in making bread.

As described above, the embodiments of the present invention provide a bread maker and a method of controlling the same, in which an expiration date of a mixing bag is automatically or manually checked to warn a user of the expiration of the mixing bag. Further, the present invention provides a bread maker and a method of controlling the same, in which an expired mixing bag is prevented from being used in making bread.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bread maker, comprising:
a main body forming an oven compartment;
a pair of kneading drums spaced apart from each other inside the oven compartment, each kneading drum having a holding part holding opposite ends of a mixing bag containing ingredients for bread;
a bar code reader reading a bar code printed on, or applied to, the mixing bag to obtain bar code information;
a timer recording a present time; and
a controller determining whether the mixing bag has expired by comparing an expiration date of the mixing bag obtained from the bar code information with the present time transmitted from the timer, and warning a user when the mixing bag is determined to be expired.

2. The bread maker according to claim 1, further comprising a display part on the main body, wherein the controller controls the display part to display the expiration of the mixing bag when the mixing bag is determined to be expired.

3. The bread maker according to claim 1, further comprising a drum driving part rotating the kneading drums, wherein the controller controls the drum driving part to rotate the kneading drums in a direction that unwinds the mixing bag from the kneading drums when the mixing bag is determined to be expired.

4. The bread maker according to claim 2, further comprising a drum driving part rotating the kneading drums, wherein the controller controls the drum driving part to rotate the kneading drums in a direction that unwinds the mixing bag from the kneading drums when the mixing bag is determined to be expired.

5. The bread maker according to claim 1, further comprising a drum driving part rotating the kneading drums, wherein the controller controls the drum driving part to stop the kneading drums from rotating when the mixing bag is determined to be expired.

6. The bread maker according to claim 3, wherein the controller controls the drum driving part to stop the kneading drums from rotating when the mixing bag is determined to be expired.

7. The bread maker according to claim 4, wherein the controller controls the drum driving part to stop the kneading drums from rotating when the mixing bag is determined to be expired.

8. The bread maker according to claim 1, wherein the kneading drums comprise an upper kneading drum and a lower kneading drum, and the bar code reader is placed within the bread maker near the upper kneading drum.

9. The bread maker according to claim 1, wherein the bar code is manually read using a handheld bar code reader.

10. The bread maker according to claim 1, wherein the warning of the expiration is an audio warning.

11. The bread maker according to claim 1, further comprising:
a rotation sensing part that senses rotation of the kneading drums; and
a drum driving part that rotates the kneading drums.

12. The bread maker according to claim 11, wherein when the mixing bag has expired, the controller controls the drum driving part to rotate the kneading drums in a direction that unwinds the mixing bag from the kneading drums, and to return the kneading drums to an initial position at which the mixing bag is attached to the kneading drums based upon a rotated position of the kneading drums sensed by the rotation sensing part.

13. The bread maker according to claim 1, wherein when the mixing bag has not expired, the controller controls the kneading drums according to the bar code information.

14. A method of controlling a bread maker having a main body forming an oven compartment, and a pair of kneading drums spaced apart from each other inside the oven compartment, each kneading drum having a holding part holding opposite ends of a mixing bag containing ingredients for bread, the method comprising:
reading an expiration date in a bar code printed on, or applied to, the mixing bag;
determining whether the mixing bag has expired according to the read expiration date; and
warning a user of expiration of the mixing bag when the mixing bag is determined to be expired.

15. The method according to claim 14, further comprising rotating the kneading drums in a direction that unwinds the mixing bag from the kneading drums when the mixing bag is determined to be expired.

16. The method according to claim 14, further comprising stopping the kneading drums from rotating when the mixing bag is determined to be expired.

17. The method according to claim 15, further comprising stopping the kneading drums from rotating when the mixing bag is determined to be expired.

18. The method according to claim 14, wherein the expiration date is read by a bar code reader placed within the bread maker near an upper one of the kneading drums.

19. The method according to claim 14, wherein the bar code is manually read using a handheld bar code reader.

20. The method according to claim 14, wherein the warning of the expiration is an audio warning.

21. The method according to claim 14, further comprising sensing rotation of the kneading drums and, when the mixing bag has expired, rotating the kneading drums in a direction that unwinds the mixing bag from the kneading drums, and returning the kneading drums to an initial position at which the mixing bag is attached to the kneading drums based upon the sensed rotation.

22. The method according to claim 14, further comprising, when the mixing bag has not expired, controlling the kneading drums according to information read from the bar code.

23. A method of controlling a bread maker having a main body forming an oven compartment, and a pair of kneading drums spaced apart from each other inside the oven compartment, each kneading drum having a holding part holding opposite ends of a mixing bag containing ingredients for bread, the method comprising:
attaching the mixing bag to the kneading drums positioned at an initial position, and rotating the kneading drums to wind the mixing bag on the kneading drums;
sensing rotation of the kneading drums;
reading a bar code on the mixing bag to obtain bar code information, and determining an expiration date of the mixing bag from the bar code information;
determining a current date, and comparing the expiration date with the current date to determine whether the mixing bag has expired;
displaying a warning message, when the mixing bag is determined to be expired, to warn a user of the expiration of the mixing bag, and rotating the kneading drums to unwind the mixing bag therefrom and return the kneading drums to the initial position based upon the sensed rotation, and preventing further rotation of the kneading drums; and
controlling the kneading drums, when the mixing bag is determined not to be expired, to knead the dough according to the bar code information.

24. The method according to claim 23, wherein the expiration date is read by a bar code reader placed within the bread maker near an upper one of the kneading drums.

25. The method according to claim 23, wherein the bar code is manually read using a handheld bar code reader.

26. The method according to claim 23, wherein the warning of the expiration is an audio warning.
